(19) United States
(12) Patent Application Publication
(10) Pub. No.: US 2010/0262296 A1
(43) Pub. Date: Oct. 14, 2010

(54) LIGHTING CONTROL SYSTEM AND METHOD

(75) Inventors: Gregory Davis, Maynardville, TN (US); Moshe Shloush, Knoxville, TN (US)

Correspondence Address: THE MUELLER LAW OFFICE, P.C., 12951 Harwick Lane, San Diego, CA, 92130, US

(73) Assignee: HID LABORATORIES, INC., Menlo Park, CA (US)

(21) Appl. No.: 12/826,666

(22) Filed: Jun. 29, 2010

Related U.S. Application Data
(63) Continuation-in-part of application No. 12/482,570, filed on Jun. 11, 2009.
(60) Provisional application No. 61/075,371, filed on Jun. 25, 2008.

(51) Int. Cl. G05B 15/00

(52) U.S. Cl. 700/275; 700/286; 700/276

(57) ABSTRACT

A system for the control of a set of powered utilities is disclosed. The system comprises a first device which in turn comprises a processor capable of altering a state of a first powered utility. This first device further comprises a data port configured to transmit a set of messages. These messages include a transmitted message delivered from the processor. The system additionally comprises a second device which in turn comprises a second processor capable of altering a state of a second powered utility. The second processor is configured to selectively alter the state of the second powered utility based on the transmitted message.

### CROSS-REFERENCE TO RELATED APPLICATIONS

This patent application is a continuation-in-part of U.S. patent application Ser. No. 12/482,570 filed Jun. 11, 2009, which claims the benefit of U.S. Provisional Patent No. 61/075,371 filed Jun. 25, 2008. The contents of U.S. patent application Ser. No. 12/482,570 and U.S. Provisional Patent No. 61/075,371 are incorporated herein by reference.

### FIELD OF THE INVENTION

The invention described relates generally to the control of powered utilities, and more specifically to the control of lighting devices with onboard processing capabilities.

### BACKGROUND OF THE INVENTION

Recent advances in ballast-controlled lighting devices have led to the availability of programmable luminaires. Some of these devices include microprocessors for control of the devices, e.g., providing automated dimming capabilities and power management features.

On-board processing capabilities allow local control of certain operating parameters. To date, such control has been limited to traditional lighting aspects, such as activity sensors to illuminate an area only when it is occupied, timer mechanisms to disable some or all of the lights in a lighting system during periods when a facility is not occupied, automatic dusk/dawn control and the like.

Significant energy savings, light pollution reduction, and equipment life advantages might be obtained if more sophisticated approaches were used to controlling lighting systems than are currently employed.

Known disclosures have described some efforts to address some of the aforementioned issues, for instance through use of a single microprocessor controlling multiple lamps. These prior approaches do not take full advantage of local processing power now available at the luminaires themselves, and a need remains for improved control methods and systems that make more use of such on-board local processing capability.

### SUMMARY OF INVENTION

In one embodiment of the invention, an apparatus for control of a powered utility is disclosed. The apparatus comprises a processor capable of altering a state of the powered utility. The apparatus additionally comprises a data port configured to transmit a set of messages, which include a message delivered from the processor. In addition, the data port on the apparatus is configured to autonomously form a network communication channel with a similar apparatus.

In another embodiment of the invention, a system for control of a set of powered utilities is disclosed. The system comprises a first device comprising a first processor capable of altering a first state of a first powered utility. The first device further comprises a first data port configured to transmit a set of messages which include a transmitted message delivered from the first processor. The system further comprises a second device comprising a second processor capable of altering a second state of a second powered utility. This second processor is configured to selectively alter the second state based on the transmitted message.

In another embodiment of the invention, an apparatus for control of a powered utility is disclosed. The apparatus comprises a processor capable of altering a state of the powered utility. The apparatus also comprises a data port configured to transmit a set of messages which include a transmitted message delivered from the processor. The apparatus also comprises a sensor port configured to connect to a dumb sensor device. The processor intelligently processes basic sensor data received from the dumb sensor.

### BRIEF DESCRIPTION OF THE DRAWINGS

FIG. 1 illustrates a block diagram of an apparatus augmented with a processor that is in accordance with the present invention.

FIG. 2 illustrates a block diagram of a utility network that is in accordance with the present invention.

FIG. 3 illustrates a block diagram of a daisy-chain connected network of utilities that is in accordance with the present invention.

FIG. 4 illustrates a block diagram of a serial ring network of utilities connected to a communications bridge that is in accordance with the present invention.

FIG. 5 illustrates a block diagram of a network comprising a network of serially connected gateways that is in accordance with the present invention.

FIG. 6 illustrates a process flow chart of a method for utilizing a Hardware Abstraction Layer (HAL) that is in accordance with the present invention.

FIG. 7 illustrates a block diagram of a lighting solution for a facility that is in accordance with the present invention.

FIG. 8 illustrates a lighting solution for a roadway that is in accordance with the present invention.

FIG. 9 illustrates a lighting solution for a retail facility that is in accordance with the present invention.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used with another embodiment to yield a still further embodiment. Thus, it is intended that the present subject matter covers such modifications and variations as are within the scope of the appended claims and their equivalents.

A device such as a lighting or HVAC utility that is in accordance with the present invention is augmented with a processor that enables it to independently or cumulatively; obtain sensor data and event data, receive command data, change its state in response to said data, generate information regarding its operating condition and history, and network with other devices or a controller by delivering messages produced by said processor. Packets or quanta of sensor data, event data, and command data are all referred to herein and in the appended claims more generally as messages. Although exemplary embodiments of the invention are described below wherein the device is a luminaire comprising a high intensity discharge lamp, it will be apparent to a person of ordinary skill in the art that apparatuses and methods described herein can be used in conjunction with any powered utility or sensor.

### Enabled Devices and Sensors

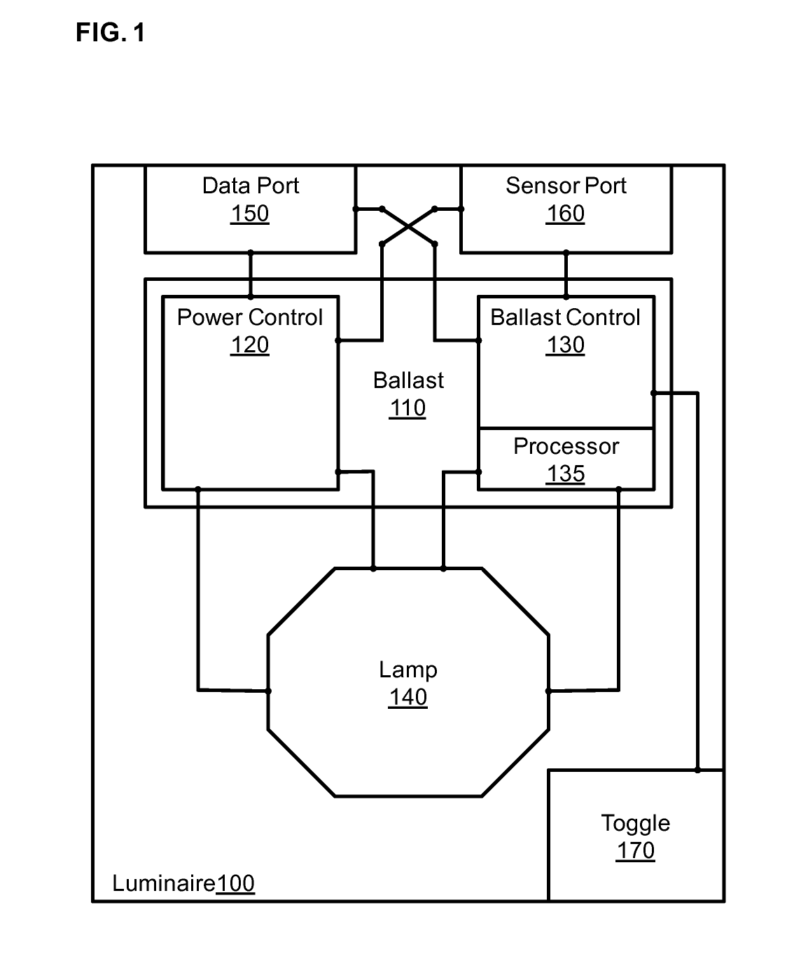

FIG. 1 illustrates a device that is in accordance with the present invention. FIG. 1 displays a block diagram of luminaire 100, including ballast 110 and lamp 140. In a specific embodiment, lamp 140 is a high intensity discharge lamp, such as a mercury vapor lamp, a metal halide lamp, or a high pressure sodium lamp. In other embodiments, other types of lamps for which ballast control is desirable are used for lamp 140. In a specific embodiment, ballast 110 is a programmable ballast including a power controller, power factor correction (PFC) circuit 120 and a ballast control circuit 130. In a specific embodiment, power controller 120 includes a power factor correction circuit for providing electricity to lamp 140 and a peripheral power supply circuit for providing power to devices connected to luminaire 100. Ballast control circuit 130 includes a processor 135 which, in a specific embodiment, is a programmed digital signal processing device such as a Texas Instruments Series TMS320 device. Luminaire 100 also includes a data port 150 and a sensor port 160. In a specific embodiment, power controller 120 allows luminare 100 to turn lamp 140 on and off and to dim lamp 140 without the need for an expensive power relay. Luminaire 100 also includes a toggle switch 170 to set which mode luminaire 100 will operate in as described in more detail below.

In specific embodiments of the present invention, both ports 150 and 160 have data connections to ballast control circuit 130 so as to allow programmable control and communications capabilities to ballast control circuit 130. Sensor port 160 allows for connection to environmental and other sensors. In specific embodiments of the present invention, a sensor is connected to luminaire 100 via sensor port 160. Sensor port 160 thereby allows for sensor data to be taken in and utilized by luminaire 100. Data port 150 allows for networked communication with a controller or another device. Therefore, the same sensor mentioned above linked to sensor port 160 can be used by other devices or controllers that are networked with luminaire 100. In specific embodiments of the present invention, both ports 150 and 160 have power connections to power control circuit 120 so as to be able to provide a required amount of power to attached devices or sensors. In specific embodiments of the present invention, ports 150 and 160 are both intended for general purpose use with a variety of connected devices and sensors. Additional flexibility is achieved by the ports being configurable for either unidirectional or bidirectional communications, under any of a number of conventional communications protocols. In one embodiment, each of ports 150 and 160 are compatible with RS-232, RS-484, Uniform Serial Bus (USB), Ethernet with TCP/IP, Wi-Fi (802.11), ZigBee, and other wireless or wired standards. In one embodiment, each of ports 150 and 160 include single-wire bus connections with auto-detect of what is connected at any particular time. In a specific embodiment, ports 150 and 160 have a base configuration of a low-cost serial digital interface such as RS-232.

In another specific embodiment, ports 150 and 160 are capable of receiving digital data through connections such as CAT5 or RJ45.

In specific embodiments of the present invention, data port 150 provides a device such as luminaire 100 with networked communication capabilities for communication with a controller or another device. This is in contrast to prior art devices where sensor data is shared through analog signal lines such as a copper wire carrying a 0-10V signal. Utilization of processor 135 to analyze and deliver messages allows for the control of devices on a network without the use of lossy analog signal lines. Wiring a network of devices is therefore much less complex, can be done over much greater distances, and without expensive copper wiring. In a specific embodiment of the present invention, data port 150 is configured to automatically detect the topology/protocol of the network to which it is attached. For example, data port 150 could detect a connected topology when a network connection is made and certain pins on a socket are thereby shorted. As another example, the connection of a cable to a first receiver port could indicate that luminaire 100 is in a daisy-chain topology and needs to forward messages through a second transmitter port. Embodiments of the present invention supporting multiple topologies/protocols and the automatic detection of said topologies/protocols could advantageously be applied to facilities having devices operating under highly variant topologies/protocols without the need for costly infrastructure changes to accommodate additional devices.

In specific embodiments of the invention, sensor port 160 and processor 135 are configured to function with both intelligent and “dumb” sensor units. Therefore, the sensors attached to luminare 100 do not need to have their own onboard processing capabilities because any required processing can be executed internally by processor 135. For example, a simple photodiode-based light sensor could transmit an analog signal when detecting light of a certain level and not transmit a signal when sufficient light was not detected. Other examples of simple sensors include a simple transducer, a thermistor, or a microphone. More complex sensors are capable of intelligent actions such as detecting a lack of motion for a period of 15 minutes, and only then sending a signal to an attached device instructing the device to output less light to save power. However, a device with its own onboard processing capabilities could receive a simple signal from the photodiode-based light sensor and could set its own internal timer to wait for 15 minutes before dimming. Use of simple low-costs sensors could decrease the cost of a given system, and could additionally facilitate the connection of a sensor to every device in a system rather than sharing a single sensor among a group of devices. In specific embodiments of the invention, processor 135 can be used to emulate a wide degree of intelligent processes that were heretofore executed by intelligent sensors, thereby providing the same functionality with a much cheaper sensor. However, in other specific embodiments, the sensors do have their own on-board processing and they communicate interactively with processor 135 for the control of attached devices. In specific embodiments of the invention, sensor port 160 automatically detects a connected sensor type and provides appropriate power via power controller 120, and optionally or additionally provides data communication capabilities via ballast control circuit 130 to allow operation with a variety of sensors. Sensor port 160 can in some embodiments be aided by processor 135 in the provisioning of this functionality. With the availability of this functionality, sensors attached to luminaire 100 do not need to have an alternative power source and complex wiring systems. In addition, the sensors may follow highly variant data communication standards, and they will still be able to communicate with the sensor. In one embodiment, pins in sensor port 160 are configured so that by dropping certain pin connections to ground signal level for each type of dumb sensor, a code can be provided identifying the type of dumb sensor. For instance, in one specific embodiment, a connection drops pin 10 to ground to indicate a thermistor and pin 11 to ground to indicate a photodetector.

In specific embodiments of the invention, ballast control circuit 130 can not only transmit and receive data through port 150 and 160 with high flexibility, but can also selectively respond to said data. The ability to selectively respond to messages produces a high degree of functionality given that processor 135 allows for high level processing of received data and a wide degree of control options for the power applied from ballast 110 to lamp 140. A baseline advantage of this configuration is that luminaire 100 can selectively react to messages and alter a state of lamp 140 without the need for costly power relays that adjust the power delivered to the lamp based on analog sensor inputs. This is in contrast to legacy systems where sensor input was provided in analog form to control a power relay that would then adjust the amount of power provided to a lamp. Many more refined power response options are available to device enabled in accordance with embodiments of the present invention to selectively respond to received messages. Altering a state of a device enabled in accordance with the present invention as referred to herein and in the appended claims comprises dimming or brightening a light, increasing or decreasing the output of an HVAC system, activating a camera, activating a misting system, opening or closing a doorway, activating a humidifier, and other alterations.

In specific embodiments of the invention, the intelligence provided by processor 135 allows for a myriad of additional responses to collected messages. In a specific embodiment, as luminaire 100 receives information regarding activity in a facility, ballast 110 is changed from an “idle” state to a “ready” state that, while still relatively low-power, allows luminaire 100 to be brought up to full brightness much more quickly than from idle state. From “ready” state, power consumption can be quickly controlled as desired to either increase or decrease light output. In one specific embodiment, ballast control circuit 130 programmably provides differing waveforms to accomplish the desired dimming profile. In one embodiment the waveform frequency is altered for dimming; in a second embodiment, waveform shape is altered; those skilled in the art will appreciate that a combination of waveform parameters may be altered to achieve effective dimming, depending on the type of lamp that is to be controlled. Since often a facility will be lit by several different types of lamps, the software control in some embodiments includes use of a lamp specific lookup table, transfer curve or similar mechanism to allow linear or other desired dimming characteristics for each controlled lamp. In some applications, dimming is based on more than one parameter; for example, motion sensing may be based on desired power to lamps while daylight harvesting may be based on desired lumens for the illuminated area. Again, selective message response control permits each event (e.g., motion sensor signal or daylight harvest level) to cause the lamp to be set to the desired output, whether such output is considered in terms of power used, lumens produced, or some other factor. Furthermore, different types of inputs are usable for controlling utilities other than lighting. For example, in a humidity-controlled greenhouse, input from a daylight harvesting sensor suggesting a very cloudy and therefore potentially rainy day is usable to reduce the typical amount of misting that will be provided to plants, since the ambient air is likely to be more humid and less sunlight is likely to reduce normal transpiration and evaporation.

In many applications, the sunk costs of legacy lighting systems are too great to permit complete changeover to enabled luminaires with selective message response such as luminaire 100. In order to provide some of the advantages of luminaire 100 while maintaining portions of legacy lighting systems, ports 150 and 160 are configurable to provide control of external legacy devices as well as lamp 140. For example, in specific embodiments data port 150 includes a standard 0-10V analog output to act as an input for a legacy device that would otherwise be connected to a legacy dimming signal. In addition, in specific embodiments of the invention data port 150 may be configured to adjust the power flowing through a power relay to turn a legacy device on or off. In addition, in specific embodiments sensor port 160 will additionally comprise control pins capable of responding to legacy analog dimming signals such as a standard 0-10V scaled dimming signal. In still other embodiments, the components of luminaire 100 other than lamp 140 are packaged as a unit for connection to such legacy systems, to effectively provide the ability to control and communicate as if they were the same as luminaire 100. These embodiments could optionally include a power relay responsive to processor 135 such that the packaged unit could adjust the power to a legacy device in the same way that ballast 110 adjusts the power to lamp 140.

### Event-Driven and Autonomous Control

Devices that are enabled in accordance with the present invention are independently or cumulatively capable of event-driven and autonomous control. In accordance with the present invention, a device such as luminaire 100 or any other lighting, HVAC, or other powered utility can be configured to allow for a device with event-driven autonomous control. Autonomous control refers to the fact that the devices can form a network, can create messages, and can selectively respond to messages (alone or in a network) and can do so without the use of an external controller. Although a controller is not needed for a network enabled for autonomous control, the addition of a controller such as a personal computer can provide significant benefits. Event-driven control refers to the fact that messages and device responses are decoupled thereby allowing individual devices to selectively respond to messages regardless of content.

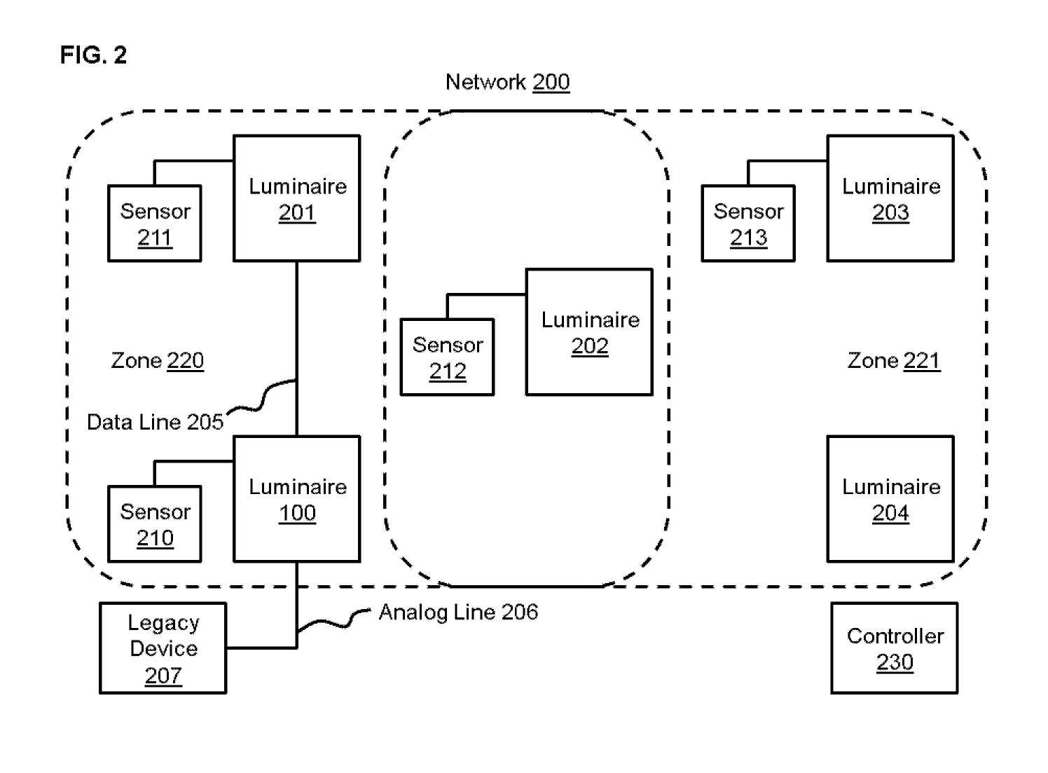

In specific embodiments of the present invention, devices such as luminaire 100 may be networked into an event-driven network 200 as illustrated in FIG. 2. Although network 200 is shown with specific devices connected by lines such as data line 205, the present invention will function with any topology including hub-and-spoke, wireless broadcast, or any other network topology. Luminaires 100 and 201 are able to connect through data line 205 without the need for a central controller to administrate the network. A central controller is not needed because luminaires 100 and 201 are self-addressing. In addition, luminaires 100 and 201 are able to automatically detect when they are connected to a network. In specific embodiments of the invention, luminaire 100 can detect that it is connected to a network and discern what type of topology it is connected to based on the physical connections to its data port 150. Once networked, the individual luminaires can create and share messages as described in more detail below.

In specific embodiments of the present invention, each device in network 200 can selectively react to, and may additionally generate event data. This functionality facilitates the implementation of an event-driven network. As shown in FIG. 2, luminaire 100 is connected to sensor 210 and luminaire 201 is connected to sensor 211. The sensors can be any of various kinds such as daylight harvesters, motion sensors, a simple analog switch, a rotary knob light switch, a temperature sensor, a camera, and various other kinds of sensors. Luminaire 100 can receive sensor data from sensor 210 and produce event data based on the received sensor data. In addition, luminaire 100 can produce event data based on its own operating condition and history. This event data can then be sent through data line 205 where it will be received by luminare 201. Once received, luminare 201 can then selectively consume the received event data and react in response or it can ignore the event data. Alternatively or additionally, luminare 201 can forward the event data to other luminaries such as luminare 202. Thus in contrast to the prior art, individual devices do not receive commands as to what they should do, rather they receive information regarding the status of another device or sensor in the form of event data, and then selectively decide themselves how to react. Since each device in such a network becomes its own controller, there is no need for a central controller to administrate the system. Also, since the devices decide how to react to event data individually, a much greater degree of flexibility is provided to the manner in which network 200 collects and responds to data.

In specific embodiments of the present invention, the ability of devices such as luminaire 100 to take in and process sensor data can be applied to systems using legacy analog systems. Luminaire 100 may be able to take in 0-10V legacy sensor data and translate the information into event data for use by other devices such as luminaire 201. Luminaire 100 may also be able to take in 0-10V legacy sensor data and boost the signal for transmission along an analog data line 206 or boost the signal for transmission along multiple data lines. Luminaire 201 may also be able to take in digital data from data line 205 and retransmit it as a legacy analog signal for use by a legacy device connected to network 200 such as legacy device 207.

In specific embodiments of the present invention, the functionality of network 200 can be enhanced through the introduction of zones within the network. The operation of a network with the use of zones can be described with reference again to FIG. 2. FIG. 2 displays network 200 that has been divided into two zones; zone 220 and zone 221. Zone 220 comprises luminares 100, 201, and 202. Zone 221 comprises luminare 202, 203, and 204. In specific embodiments, each individual luminare is preprogrammed with a default zone. In addition, each connection on a sensor port may be preprogrammed with a default zone. However, in specific embodiments each luminare can be programmed with a list of zones to which it belongs and in addition each connection on a sensor port can be programmed with a list of zones. For example, luminare 202 has been programmed with both zone 220 and zone 221 so it will respond to events that are meant to affect both of these zones. A particular advantage of dividing the network into zones is that messages can be more specifically targeted to affect groups of devices. Messages can be targeted to a zone instead of individually addressed devices.

In specific embodiments of the present invention, messages on the network are tagged with a list of zones to which they are meant to be applied. When a device obtains a message it compares the tagged zones to the zones for which it has been programmed and will respond if there is a match between the two lists. For example, when luminaire 202 receives a message that has been tagged with either zone 220 or zone 221 it will know that the received packet should be consumed and reacted to. Intelligent sensors can be provided with the zone to which their sensor data is relevant so that they can tag the information they produce with said zone. For example, sensor 210 might be able to tag any sensor data it provided to luminaire 100 with a code for zone 220. In addition, devices connected to sensors might be able to tag the received sensor data with the zone to which they belong. For example, if sensor 210 did not provide a zone code to its sensor data, then luminaire 100 could tag the sensor data with a code for zone 220. Finally, a message can be tagged with a different zone than the one in which it was physically generated. For example, sensor data obtained from sensor 211 may be tagged with zone 221 such that the event it represents will affect zone 221 even though the information was technically obtained in zone 220. The decoupling of the location at which information is obtained and the location at which information is used provides for a wide degree of additional functionality. For example, sensor 210 may be a camera that has a uniquely unobstructed view down a hallway leading to zone 221. When camera 210 detects that a person is walking down the hallway, this sensor can provide this information as event data for zone 221 at which point the luminaires in zone 221 will turn on to provide lighting in anticipation of the person's arrival.

The event-driven nature of network 200 provides a significant degree of flexibility to a device network's ability to collect and respond to data. In traditional systems, controlling a single device with multiple sensors requires switches or relay elements and is therefore very rare. It is also rare for multiple devices to respond to a single sensor in different ways. Also, the manner in which devices respond to sensors is somewhat limited. For example, in a traditional system a motion sensor will contain a timer and will wait a certain amount of time after no motion is detected and will then adjust a 0-10V command line that all connected devices will respond to. Connecting multiple sensors to any of these individual devices will be difficult because the additional sensor will have to contend with the fact that the 0-10V command line is already in use by the previous sensor. Therefore linking multiple sensors to a single device can require costly relays or switching elements. In specific embodiments of the present invention, multiple sensors can communicate seamlessly with a single device, and multiple devices can respond in different ways to a single sensor. In addition, a much greater degree of flexibility can be provided in how a device responds to a given quanta of sensor data. In addition, devices can utilize sensor data in novel ways such as using a security camera as a source of motion sensing data for turning a light on or off. Finally, since in specific embodiments the responses of devices to messages are all handled digitally, and devices can be digitally assigned to different zone lists, reconfiguration of the device network to highly different functionalities can be achieved without any physical modification of the existing device network.

In specific embodiments of the present invention, multiple sensors can communicate with each device. Sensor data obtained by sensor 210 can be turned into event data by luminaire 100 which will in turn provide the sensor data to luminaire 201. The delivery of event data from sensor 210 to luminaire 201 will not cause any conflict with sensor data obtained directly from sensor 211 because luminare 201 will process both messages and decide how to react taking both into consideration. Luminaire 201 can be programmed to selectively respond to event data from either device in whatever manner is desired. For example, luminiare 201 could ignore all information provided by sensor 211 to which it is directly connected to, and only respond to event data provided by sensor 210. In another example sensor 212 may be a daylight harvester that sends event data to luminaire 100, 201, 203, and 204. Although each luminaire will receive the same message, they each may respond slightly differently. If for example, there was a skylight close to luminaire 202, then event data from sensor 212 indicating an increase in light through the skylight could cause luminaire 202 to decrease in brightness significantly while a luminaire that was further away from the skylight such as luminaire 204 may decrease in brightness to a much smaller degree.

In specific embodiments of the present invention, multiple sensors and controllers can communicate with each device even if the messages provided would otherwise have conflicting effects on the device. For example, if each message of sensor data was meant to engender a particular device with a certain level of dimming, the device could be configured to have multiple dimming scales. Sensor 211 could be a rotary knob for dimming luminaire 201 and sensor 210 could be a daylight harvester for which luminaire 201 is programmed to respond. Assuming luminiare 201 was a 400 W lamp, the full scale range of the lamp power might be 25%-100% because 25% may be the minimum power required to sustain the 400 W lamp arc. To allow for multiple sensors, different messages related to the same performance parameter of the devices could be ranked in order of priority based on their source or other factors. For example, rotary knob 211 could be set to level 1 priority such that when it sent out event data that would otherwise instruct luminaire 201 to alter the power provided to the lamp from 0-100% luminaire 201 would provide the lamp with a corresponding power level from 25%-100% to encompass its full potential range of power input. Daylight harvester 210 could then be set to level 2 priority so that when it sent out data that would otherwise instruct luminaire 201 to alter the power provided to the lamp from 0-100% lumiaire 210 would provide the lamp with a corresponding power level from 25% to the degree by which rotary knob 211 had already diminished the full power level allowed. Therefore, if rotary knob 211 had already set the power level to 50%, then daylight harvester 210 would only be able to adjust the light from 25% to 75%.

In specific embodiments of the present invention, multiple devices can respond in different ways to a single sensor. For example, luminaires 100 and 201 could receive a message indicating a lack of movement under luminaire 100, at which point luminaire 100 may dim immediately while luminaire 201 would wait a certain amount of time before dimming. Since the response of the device and the event data are decoupled, a multitude of possible message responses are possible. The addition of zoning can greatly increase the flexibility of device networks. In one embodiment, sensor 210 is a motion sensor that is set to affect devices in zone 220 while not affecting devices that are only in zone 221. In addition, sensor 212 is a daylight harvester set to affect both zones 220 and 221. In this situation, daylight harvester 212 could set the maximum power level for luminaire 100 while motion sensor 210 set whether luminiare 100 was on or not at all. At the same time, luminiare 203 would have its lighting level set solely by daylight harvester 212.

The response of a single device to specific event data could also change depending upon event information obtained from a sensor. For example, luminaire 203 could be programmed to respond to both a daylight harvesting sensor in the place of sensor 212 and a machine-state sensor in the place of sensor 213. Luminaire 203 may set its maximum power based on available daylight event data from sensor 212 when machine-state sensor 213 detected that a specific machine was not on. However, luminaire 203 may be programmed to ignore daylight sensor 212 when machine-state sensor 213 detected that a specific machine was on. Such a scheme could be implemented in the situation of a machine whose operation in a manufacturing facility was somewhat hazardous, where a legally defined level of lighting has to be maintained from a consistent artificial lighting source while the machine is operational. As another example, the environmental requirements for computer servers in a data center when they are idle as opposed to operating near capacity, are significantly different, and lighting and HVAC requirements in this application are adjustable in one embodiment based on such operational conditions. In this situation, the devices would need to be networked with some form of sensor that could monitor the operating condition of the computer servers.

The fact that sensor data and event data can be shared among multiple devices leads to beneficial synergies. In a specific embodiment of the present invention, daylight harvesting sensors are connected to luminaires 100, 201-204. One example of such a daylight harvesting sensor is a video camera, with certain pixels being chosen as indicating locations in which changes in illumination suggest changes in available daylight. Due to issues such as shadows from ceiling beams that move as the sun traverses the sky, changes in brightness based on people wearing dark clothing or darkly colored equipment being moved through the area, etc., the output from each sensor may not be reliable at all times. By averaging the information provided by multiple such sensors, however, e.g., from different pixel locations from one video camera and by multiple cameras at each of the luminaires, a far more reliable indication of available daylight is provided. Processing of events from each sensor by each luminaire allows such benefits to be achieved, and also permits additional processing to produce improved results. For example, hysteresis processing is used in one embodiment to prevent small changes in sensed brightness causing constant adjustment of brightness; in another embodiment, damping processing is used to prevent a change in brightness of, say, luminaire 201 to be interpreted as a change in available daylight at, say, luminaire 100. Without such processing, open-loop effects such as strobing can occur that result in uneven and distracting lighting effects. Further techniques to prevent such artifacts, such as luminaire 201 taking into account in its daylight harvesting processing event data from luminaire 100 conveying the fact that luminaire 201 has just increased its output, ensures that the overall system responds only to input information that truly indicates a change in available daylight.

The benefits that accrue from devices sharing sensor and event data can also lead to beneficial results in mixed device networks. For example, consider a facility with a large lighting system that produces a great amount of heat. It may be important for the HVAC system to know that a drop in sensed temperature is the result of the lights being turned off rather than the outside temperature dropping. By having the luminaires send event messages stating that they are being turned off, the HVAC system may ignore a corresponding drop in temperature rather than triggering the system to turn on the heat. This is often the sensible approach at the end of a workday, when the lights go off and lower temperatures may be tolerated. Those skilled in the art will recognize that many different applications will allow devices to benefit from events communicated both from sensors and from other devices, in this manner.

In specific embodiments of the present invention, the devices on a network can have certain fail-safe systems in case the network fails. In a specific embodiment, the devices can have override time-outs in case a stream of events falls outside an expected modality. Such a system could be provided when for example, a light is told to stay dim during a period when a system designer knows that the light will be needed often. The device could include a time out counter that would return it to its usual state after a given period of time. This type of fail-safe system is extremely important for situations where a sensor or controller is disconnected from the system after instructing the connected devices to go into one phase before getting an opportunity to tell the devices to return to the previous phase. Another fail-safe system that can be employed covers the situation where a device misses a message or is connected to a network after the message was sent. This fail-safe comprises the transmission of redundant messages that are ignored by devices that already received the message and could possibly be received by devices that missed the message in the first place.

Although networks in accordance with specific embodiments of the invention are autonomous in that devices such as luminaire 100 and luminare 201 can automatically connect to the network, there are certain benefits that can accrue from the addition to the network of a controller such as controller 230. For example, the addition of controller 230 can provide a service technician a central access point for administrating a complex network. Also, since individual devices are able to create messages regarding their own status and operating parameters, a controller 230 may be able to collect information on energy usage, on-off duration, and device performance for all the devices on network 200. This information could be used as part of a preventative maintenance list of devices that need replacement or are running inefficiently because they are near the end of their useful lives. Embodiments of the invention that combine this aspect with a cross referenced database of the physical locations of the devices on the network are therefore highly advantageous. In addition, controller 230 can create event data or command data that overrides other messages if the network needs to be adapted for a different function or to troubleshoot the network. For example, central controller 230 could override the priority of multiple dimming scales and be able to set individual lights to any percentage of full power. The central controller can also be used to reconfigure the functionality of the network by, among other things, redefining the zones that comprise the network, redefining how specific devices react to specific event data, and what form messages on the network will take. As mentioned previously, this would allow for drastic alterations in the functionality of a device network without the need for any physical alteration of the network. For example, it may be determined that the time a luminare waits before going out should be altered in a facility that is sparsely populated after a certain time. Control unit 230 would be able to implement this objective by altering the event responses of all the devices in the network simultaneously. As another example, in the case of a daylight harvester in place of sensor 212 to which all the luminaires in FIG. 2 respond as described above, a control unit 230 could centrally calibrate the degree to which each of the luminaires in a network would dim in response to the daylight harvester's dimming message. Importantly, devices in accordance with embodiments of the present invention are able to maintain their programmed state even after the controller is disconnected. This would allow initial configuration of a network without the need for a permanent controller. Controller 230 could be implemented by a personal computer to keep the costs of implementation low.

In specific embodiments of the invention, individual devices on the network can be set to any one of a number of modes. The modes could comprise a device mode, command mode, network mode, and automatic mode. Device mode would instruct the device to only respond to an analog device directly connected to it, thereby allowing the device to exactly mimic traditional legacy systems. Command mode would instruct the device to respond only to commands from a controller and to ignore messages from sensors or devices. Network mode would instruct the device to respond to other devices and sensors while at the same possibly responding to commands from a controller as well. Network mode could also instruct the controller to incorporate any of the networking methods described above. Automatic mode will allow the device to set itself to any of the previously described mode by detecting what is connected to the device. For example, the device could detect if any network devices were connected and default to the network mode. If only analog hardware devices were detected, the device could set itself into device mode. As shown in FIG. 1, luminaire 100 could additionally comprise a toggle switch 170 that would allow a user to set the mode in which the luminaire would be operating. However, luminaires such as luminaire 100 could also select their mode without the use of a toggle switch by using digital logic based on detecting what devices were physically connected to luminaire 100.

### Network Topology

Particular networking topologies combine advantageously with the concepts addressed above in regard to devices such as lighting and HVAC utilities networked with other devices or sensors. In specific embodiments of the invention, a daisy-chain or serial ring network topology can be beneficially applied because it is less costly than other topologies. Devices such as luminaire 100 are often already connected in series to a mains power supply conduit and are therefore highly amenable to a serial ring topology. This serial ring topology can be forward transmitting or bi-directional. In other specific embodiments of the invention, multiple network topologies can be applied in a single cohesive network to provide for interaction between legacy systems and more advanced networks as well as providing for other benefits. In other specific embodiments of the invention, multiple networks can be connected through gateways to provide for additional functionality.

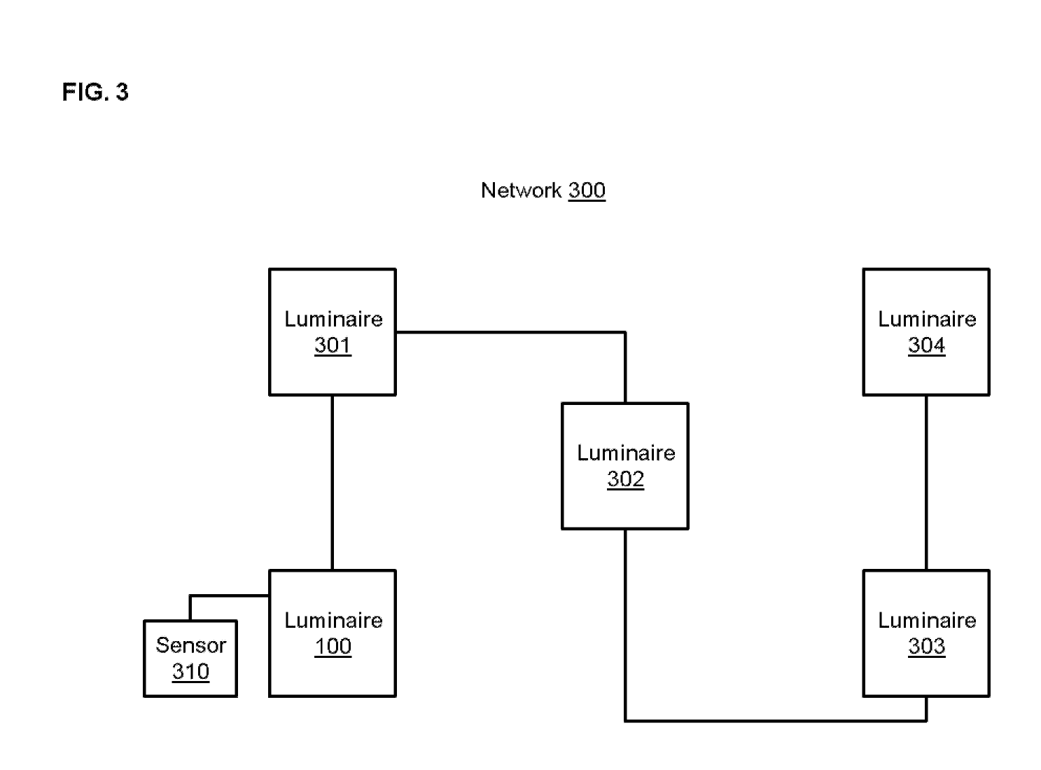

A network in accordance with the present invention can be implemented using any type of protocol such as wireless or wired Ethernet with TCP/IP, Wi-Fi (802.11), ZigBee, other wireless standards, RS-485, and RS-232. Devices in accordance with the present invention can be configured to operate according to a specific standard by detecting physical connections. For example, a device that can detect no physical connections to its data port may operate under a wireless communication standard and a device that can detect it has a data port that is connected to the Ethernet through a direct connection or an adapter can communicate through an Ethernet standard. In general, the network can be implemented using any form of digital communication. However, the topology can also be configured to take in analog signals at a particular point. For example, with reference to FIG. 3, sensor 310 may provide an analog signal to luminaire 100 which will be converted to a digital format and then sent along the network to other luminaires. In addition, in specific embodiments of the invention, the individual luminaires can be configured to transmit and receive analog signals such that the analog signals are boosted and resent at each device node in the chain.

In specific embodiments of the present invention, luminaire 100 with data port 150 is compatible with a serial-ring topology. A serial-ring topology can be described with reference again to FIG. 3. This topology allows the networking of luminaire 100 with other luminaires such as luminaires 301 and 302 in a daisy-chain manner. In specific embodiments, luminaire 100 is designed to operate in accordance with this topology as a default. This type of topology is an improvement over traditional topologies for lighting systems wherein a single analog signal is routed individually to all of the devices requiring the information. In specific embodiments of the present invention, the connections between luminaire 100 and luminares 301-304 are all digital information conduits. Therefore, the network does not have to rely on lossy analog lines. Instead the network can be implemented using standard CAT5 or RJ45 connectors.

In specific embodiments of the present invention, a network of luminaries such as luminaire 100, connected in accordance with the daisy-chain topology are capable of autonomously configuring a network. Data port 150 is configured with a daisy-chained messaging system with a method to accept an inbound cable and an outbound cable. This is accomplished, for example, by data port 150 having two cable jacks or alternatively a coupler splitting device (such as a t-connector found in older coaxial Ethernet systems). Autonomous configuration can therefore begin when luminaire 100 determines that it only has a cable connected to its OUT port, and configures itself as a master. Next, luminaires 301-303 have cables connected to their IN ports as well as their OUT ports, so they configures themselves as repeaters. Finally, luminaire 304 only has a cable connected to its IN port so it will configure itself as a terminator. Once the network is so configured, messages can thereby be passed along a single line to any device on the network. If sensor 310 is a motion sensor that continually reports to luminaire 100 when it sees motion, luminaire 100 can wait a predetermined amount of time and then create an event message stating that there is no motion under the sensor. The message will be passed down the chain and all of the luminaires will be able to respond to the information that originated with sensor 310. This method is useful in zone dimming. It is sometimes desirable to have one sensor control the dimming of a multitude of light fixtures in an area, where they all dim and brighten in unison. Traditionally, this requires extensive wiring of multiple analog control power lines. This wiring is expensive and can only be extended to a limited number of fixtures due to signal loss because of the resistance of the wire itself. The daisy-chained network above creates an autonomous digital network that requires only a single cable without the problem of analog signal loss. In specific embodiments, a controller such as a PC is swapped with any of the devices in the chain and is programmed to forward received messages along the chain and otherwise act in the same manner as a device in the chain.

In specific embodiments of the present invention, a network of luminaires such as luminare 100, can be connected in accordance with a serial ring network capable of autonomous configuration. As above, the devices can automatically detect if they are connected in a serial ring if they have physical connections to their IN and OUT ports. In contrast to the one way daisy-chain topology, the sensor device does not have to be at one end of the chain because messages are passed around the entire ring. In specific embodiments, this topology requires that luminare 304 in FIG. 3 be linked back to luminaire 100. In this topology, a message to be passed around the ring can originate at any of the four luminaries and could eventually reach the other three while only traveling in one direction. This type of configuration also allows for multiple sensors to efficiently communicate with all of the devices on the network individually or as a group.

In contrast to the one way daisy-chain network discussed above, devices on the serial ring network would need to know not to forward a message if the message was intended for the recipient device alone or if it had already been around the loop once. One approach would be to provide the message with an identification tag for the device that originated the message. When a device received the message and saw that the identification tag matched its own, it would know that the message had been passed around the entire loop and it would destroy the message. This approach could be used in combination with multicast messages that were pertinent to several devices. The identification tag could separately include a zone identification number shared by all the devices that the message was pertinent to. These devices would both consume and forward the message and only the originator device would destroy the message. This approach would have the added benefit of providing a confirmation message to the originating device.

In specific embodiments of the present invention, the final two devices in a serial-ring topology network do not need to physically have there OUT port and IN port connected. Instead, terminators can be placed on these ports to inform the devices that they are at ends of the physical chain. Referring to FIG. 3, a line would therefore not be needed to connect luminare 100 to luminaire 304 even if a serial-ring topology was deployed. In specific embodiments of the invention, data port 150 is configured to read a terminator connection as an indication that it is connected to the final or first physical link in a serial-ring chain. Devices on either end of the chain will therefore know to send a message back down the chain. For example, a message that originated with luminare 302 would be sent ahead to luminare 304, at which point luminare 304 would address the message for luminaire 100 and send the message back up the chain. Additional circuitry can be added to boost these messages since they will be traveling the whole chain but portions of the protocol may only think they are going a single step.

In specific embodiments of the present invention, more precise addressing schemes could allow more refined communication among sensors and devices within the serial ring. For example, each device could be given a unique address and messages that originated elsewhere intended for that device could be sent with that address embedded. The recipient device would consume the message and only forward its response. In another example, each message could be provided with an originator address and a recipient address. Each device that received the message could determine if the recipient address matched their own. If the addresses matched, the device would consume the message and if not the device would forward the message. Such embodiments could also provide for communication where confirmation messages could be sent back to the original device. The recipient device could consume the message and then send a confirmation message back with the recipient and originator addresses switched as compared to the original message. Both of these approaches would decrease the number of messages passing through a network as each message would only travel through the network until it was received by the device that need it. In another specific embodiment of the invention, messages could be addressed by a device or controller for consumption by another device based on a number of jumps a message would have to take as it was passed through a chain of devices. For example, a controller could send a message to a device that was four devices down the chain from the controller by sending a message with an index value of four, and a variable message value that would increment every time the message was retransmitted. Only a device detecting that the variable value and the index value matched would consume the message. In further specific embodiments of the present invention that would afford a similar benefit, devices on the network would comprise two serial ports which could enable two-way communication. Devices could be programmed to send confirmation messages back from the direction in which they were received to further cut down on the number of jumps each message would need to take.

Since the serial ring network is a looping topology there is the potential for messages to continue looping through the network indefinitely. Also, since some messages will have to pass through every device on the network there is a heightened potential for messages to be lost in transit. In specific embodiments of the invention using the addressing schemes described above, this would not be as hazardous since devices are instructed to destroy messages when they are no longer needed, and may also select embodiments provided for the return of confirmation messages. Regardless, the addition of fail-safe methods that protect against infinite looping and lost messages would provide a great degree of durability to the system. In specific embodiments of the invention, a fail-safe system takes the form of circuitry that passes a message through a device regardless of whether the recipient device is powered off or malfunctioning. In specific embodiments, each message includes a hop counter keeping track of how many times it is forwarded. If the hop counter reached a certain predefined level to indicate that a problem had occurred, a recipient device could refuse to forward the message and thereby solve the looping problem.

The various network topologies discussed above can all be used in combination with the network zoning principle discussed in the previous section. Each device in a network can contain a list of zones to which it belongs and each message can contain a list of zones to which it applies. For example, a sensor message can be tagged with the zone list of the device it is connected to, or it can be tagged with a predetermined set of zones configured by a user. As the message is passed through any of the topologies discussed above, the recipient device could compare its zone list to the zones in the message itself and take the appropriate action if a match was found between the two lists.

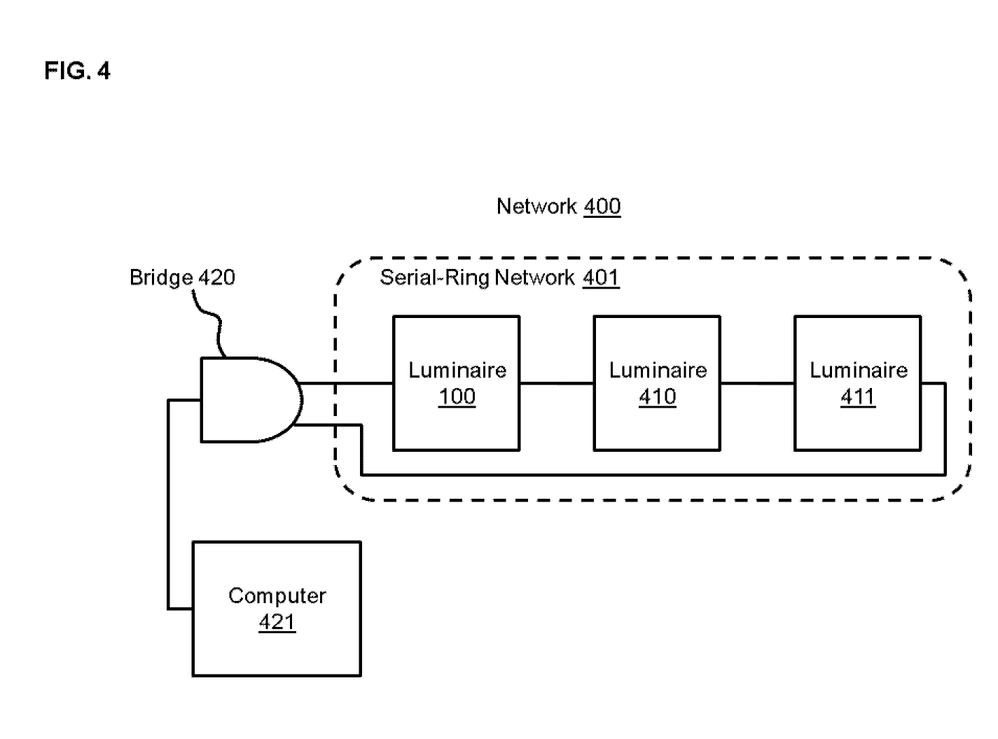

The addition of bridges or gateways can greatly enhance the functionality and performance of a network in accordance with the present invention. Among other benefits, the addition of bridges would enhance the compatibility and adaptability of device networks operating in accordance with the present invention. Also, the addition of gateways could greatly increase the efficiency and fidelity of device networks operating in accordance with the present invention. The benefits of adding gateways and bridges to a network 400 in accordance with the present invention can be described with references to FIG. 4.

In a specific embodiment of the invention, the topologies/protocols of a luminaire such as luminaire 100 are expanded using external translation devices such as bridge 420. This allows direct connection to a controller 421 in a non-networked environment, which is desirable for configuring luminaire 100 during installation. To expand luminaire 100 to operate in a networked environment, a bridge 420 translates the native topology/protocol of the facilities network to RS-232 (or whatever topology/protocol data port 150 is configured to). For instance, if the facility network is Ethernet (TCP/IP), the bridge consists of a traditional RJ-45 connector to accept the Ethernet cable. The bridge contains circuitry to hold the TCP/IP address and communicate bi-directional with the Ethernet (TCP/IP) network. Internally the bridge accepts TCP/IP messages and converts them to ASCII messages that are compatible with RS-232 (found in data port 150). The bridge maintains the TCP/IP socket (so that a return message may be sent to the proper address of the sender) and transmits the converted ASCII message to data port 150, which is received by luminaire 100 via Processor 135. Processor 135 then takes action on the received message and may send a return ASCII message out data port 150 (RS-232), which is received by the bridge. The bridge then converts the ASCII message to TCP/IP and transmits it out onto the Ethernet network via the retained TCP/IP socket.

In specific embodiments of the present invention, a serial ring network 401 comprised of luminaire 100, and luminaries 410-411 could be connected to additional networks through a communication bridge 420. This would allow the network to communicate with multiple communications protocols and topologies as described above, thereby greatly enhancing the networks ability to communicate with the variant topologies and protocols that may exist in facilities to which the network was added. For example, controller 421 could send a message wrapped in TCP/IP to bridge 420, and the bridge would strip away the TCP/IP wrapper and send the message to the serial ring. Messages coming across the bridge in the other direction would be wrapped in a reverse manner. The configuration of bridge 420 and luminaires 100, 410, and 411 is also a cost effective way to implement a bridge into a network. Since bridge 420 is connected to one end of a serial ring comprising three devices, the bridge's capabilities can be shared by every device in the chain as each device is able to send a message down and out the chain through bridge 420. This is advantageous compared to having to provide each device with a bridge. In addition to providing a high degree of compatibility, the addition of bridges greatly increases the configurability of the network. If the facility employing network 400 replaces its TCP/IP network with wireless or some other newer network at some point in the future, the bridge can be simply replaced with another bridge that matches the new network, saving the need to need to replace luminaire 100. A single computer used in place of bridge 420 could implement a bridge to multiple networks operating under various different topologies such as serial, Ethernet, or wireless protocols. The computer could also be loaded with software to allow it to function as a bridge to DALi protocol networks which are used often in legacy systems. In specific embodiments the computer will mask the devices operating in network 400 from an external network such as one operating a DALi protocol, and thereby allow seamless integration with legacy networks.

The addition of slightly more advanced bridges that could function as gateways for routing messages through the network would allow for an even more functional and robust system. Referring again to FIG. 4, it should be noted that whatever device bridge 420 is connected to needs to forward messages back through bridge 420 to maintain continuity of the serial ring messaging system. This may be problematic given that the device on the other side of the bridge may be a computer in the place of controller 421 that may be periodically turned off. In addition, it may be beneficial to simply forward messages directly back to the loop and not pass them through bridge 420 if they are only intended for the serial ring that delivered the message to the bridge in the first place or instead to copy the message and send the copy immediately back into the loop. For example, if luminaire 410 was attempting to communicate to luminaire 100 along a forward only serial-ring where messages were sent in a clockwise direction, it would be inefficient to send the message out through bridge 420 to computer 421 before sending the message back to serial ring network 401. Both of these problems can be solved through the introduction of gateways to the network.

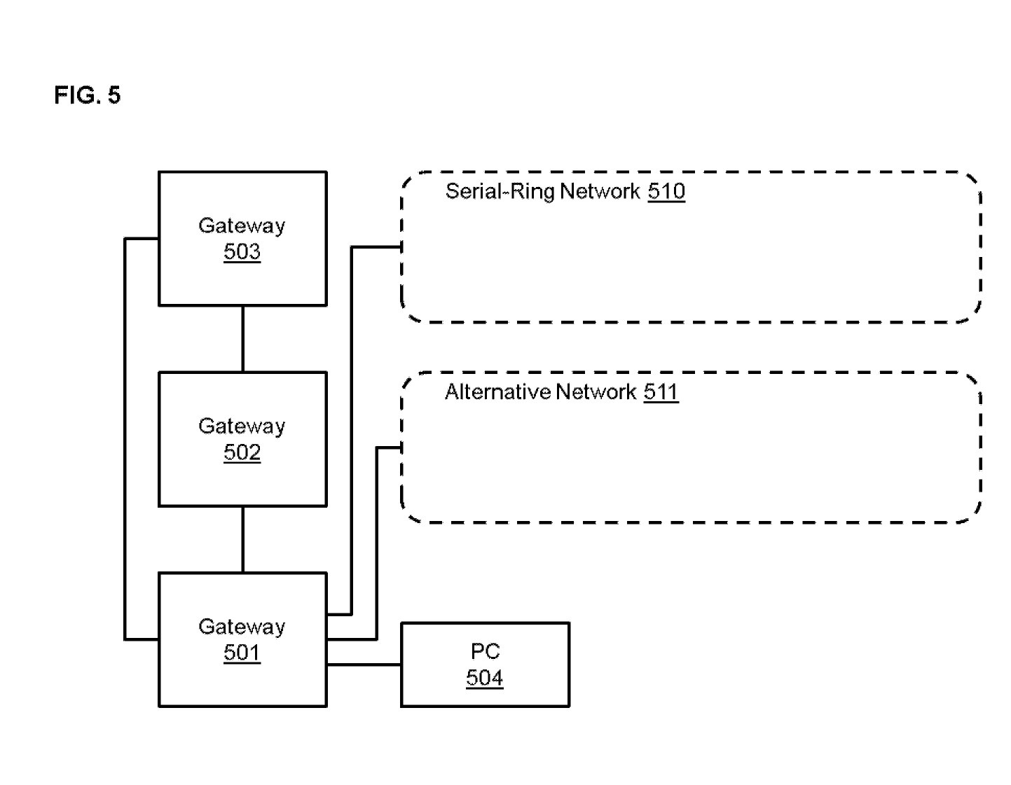

A network 500 incorporating the use of gateway devices can be described with reference to FIG. 5. Gateway 501 can be implemented using a personal computer or a dedicated gateway device. A gateway device is generally more advanced than a bridge device. However, both a gateway and a bridge can be implemented by devices that are powered by the devices they are servicing such as luminaire 100. Gateway 501 can be connected to additional gateways such as gateway 502 and gateway 503. These multiple gateways may be connected using a serial-ring topology and protocol. Gateway 501 may be linked to any number of other devices and networks such as remote computer 504, and serial rings 510, and alternative network 511. Gateway 501 comprises the capabilities of the bridge devices discussed above and in addition comprises advanced networking functionality such as advanced routing, addressing, and network query operations.

In specific embodiments of the present invention, gateway 501 is capable of connecting to multiple networks such as serial ring 510 and alternative network 511. This is advantageous in itself because the disruption of a single serial ring such as serial ring 510 will not affect other networks such as alternative network 511 which is highly beneficial as compared to a facility-wide network comprising a single serial ring wherein a major problem anywhere in the network will prevent the entire network from functioning. Gateways could serve the same purposes as bridges except that they would have the ability to determine where a message needed to be routed. In a specific embodiment, the gateway would scan the message and recognize that it was not needed elsewhere so it would not translate the message and would instead forward the message back into the serial ring. For example, gateway 501 is capable of determining if a message from serial ring 510 needs to be forwarded on to another network, or if it can simply be returned to serial ring 510 thereby decreasing the number of messages being routed through the greater network. In specific embodiments of the present invention, gateway 501 can preserve the integrity of serial ring 510 by copying a received message and immediately forwarding the copy back into the ring to preserve continuity. In specific embodiments of the present invention, gateway 501 is also capable of more advanced forwarding techniques. For example, gateway 501 may be connected to a remote computer 504 via a TCP/IP connection and may also be connected to serial ring 510 and alternative network 511. In such situation, gateway 501 is configured to receive data such as commands from remote computer 504 and to send the corresponding message onto the appropriate network without interrupting the other networks. This functionality is accomplished in certain embodiments of the invention by allowing a gateway such as gateway 501 to query a connected serial ring or other network for a list of zones on their network and only translate and send out messages that are intended for zones not on the queried network's list. Such gateways are also configurable to serve other network functions as may be appropriate, such as acting as switches, routers, and repeaters.

In specific embodiments of the present invention, the capabilities of gateways to more efficiently route packets through a network can be greatly expanded by the connection of several gateways through a serial connection. For example, gateway 501 could be connected in a serial ring to gateway 502, and gateway 503. Gateway 501 could then query gateways 502 and 503 on the network for their zone lists. If gateway 501 received a message for any zones on these lists it would know to send the message through the serial ring to the other gateways, and if not gateway 501 would forward the message on through one of its own networks. The end result would be far fewer messages being sent around the network because the gateways could specifically target other serial rings for the receipt of certain messages.

### Hardware Abstraction Layer/Application Programming Interface

The concepts addressed above discuss the wide array of potential topologies and protocols to which a network in accordance with the present invention can function. Traditionally, control software is designed to control specific hardware whose communication methods are known, as well as devices whose capabilities are known. This forms a device dependant system for the software. A software application must explicitly know the communication method of the device as well as its capabilities and how to operate these features. However, in order to capitalize on the wide ranging functionalities available when using networks in accordance with the present invention it is of extreme importance that the network not be device dependent, and instead be capable of interfacing with any potential devices such as a lighting or HVAC utility. Therefore, it is highly advantageous for networks in accordance with the present invention to utilize an application programming interface (API) that will allow a user or network designer to capitalize on the wide reaching potential functionalities and configurations of these networks as they are linked to other devices.

In a specific embodiment of the present invention, a software program includes a hardware abstraction layer (HAL) that forms API providing the benefits discussed in the previous paragraph. The HAL comprises a software library that supports high-level interfaces covering known and customized powered utility control and management software applications. System-level control software applications only interface with the interfaces found within the HAL, and do not need to be customized for individual devices. The HAL also supports low-level interfaces to control powered utilities. These devices are directly interfaced with small libraries that contain the software code necessary to communicate with the device via its hardware topology/protocol. These libraries are called device drivers. The device drivers only interface with HAL low-level interfaces. The device driver provides the capabilities of the device to the HAL and performs the actual communication and translation between the device and the HAL.

In a specific embodiment of the present invention, the application programming interfaced could be published and released to third parties. Third parties would then be able to create software applications for the platform such as high-level interfaces or device drivers as described above. This level of access would provide third parties the ability to make any software application relating to the control of the potential capabilities of a network of devices.

A description of the initialization of a HAL in accordance with the present invention can be described as follows. Initially, the devices (via their device drivers) are listed with the HAL. The control software calls a high-level function in the HAL to obtain the list of available devices. The HAL will then provide a list of the devices available to the system and the devices unique capabilities to the software program using the API. Additionally, the HAL details the type of device (light, HVAC, etc) and its capabilities. When the control software wishes to send a command to the device, it does so through a standard high-level interface in the HAL. The HAL then initiates communication with the device via a low-level function to the device driver. The device driver itself explicitly opens communication with the device. Thus, the control software calls a high-level function in the HAL to command a device to do something. The HAL calls an appropriate low-level function to the device driver which issues commands to the actual device to perform the action.

An advantage of the method described above is that control software does not have to explicitly know the details of the device it is controlling. In traditional control software, the software can only control devices that it was designed for (device dependant design). With the HAL method, control software written for devices available today can also control devices that are created after the software. The future device simply supplies a device driver to the HAL, and the control software can use it as if they were created together. This forms a device independent design.

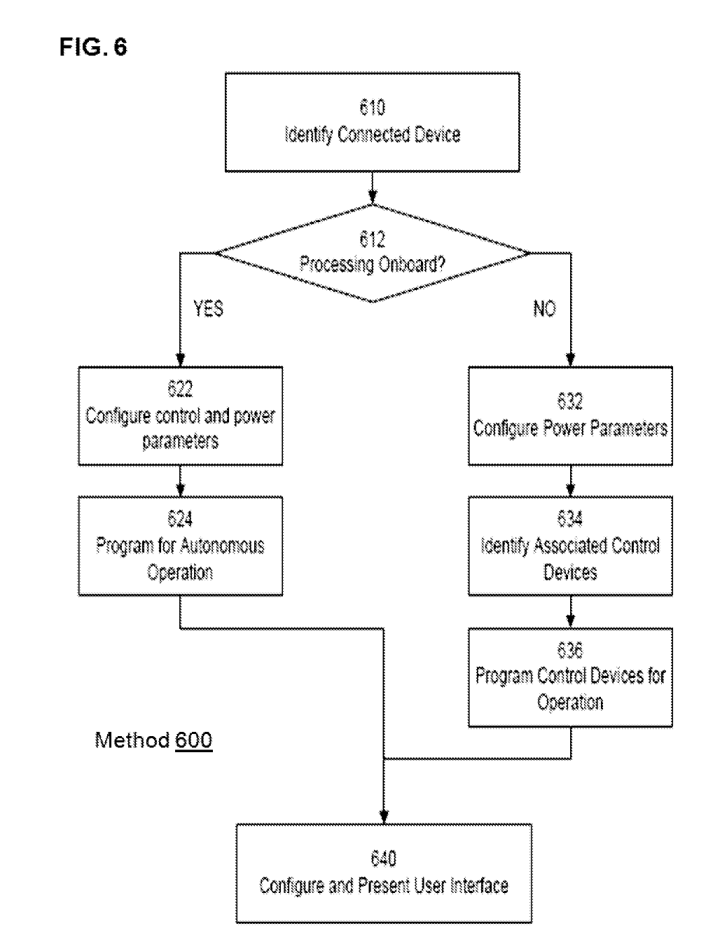

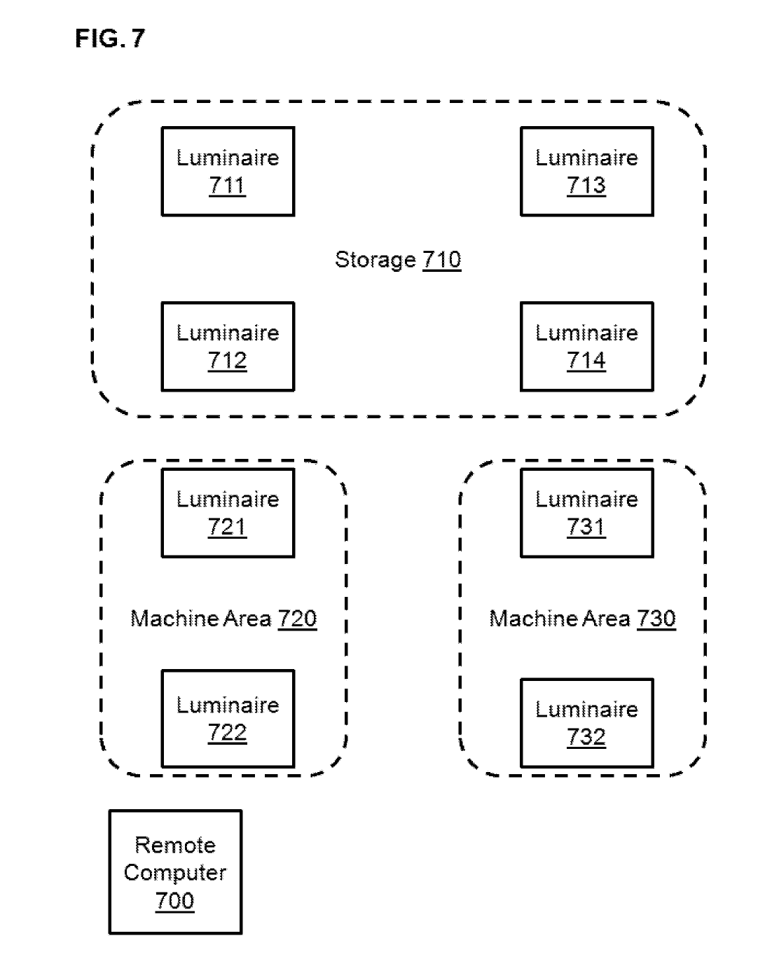

A method for processing for a lighting application program interface can be described with reference to FIG. 6 and FIG. 7. In a specific embodiment of the present invention, to which the exemplary method is applied, to further enable control of mixed systems including processor enabled luminaires and legacy components, an application program interface software subsystem is provided for a remote computer such as 700 to identify a variety of supported lighting devices and provide control to them under a common user interface for the lighting of an industrial facility. First, the connected device is identified 610. In a specific embodiment, devices with on-board processors preferably provide a unique identification code with not only an IP address, but also a device identification code. In one implementation, an identification scheme as used with USB devices is employed to uniquely identify the type of a device. To identify devices without on-board processors, such as legacy lighting systems, operating characteristics are observed at the control point for such devices. In one application, a remote switching unit with its own processor is installed in place of the conventional manual switch for a lighting circuit. The remote switching unit includes a shunting amperage detection circuit to measure the amperage flowing to a lighting circuit over time. Each type and size of lamp exhibits different surge characteristics as it is energized; the remote switching unit is configured to have a “load identification mode” in which it reports back to remote computer 700 information from which the identification of the load can be determined. In one implementation, upon receiving a request for load identification the remote switching unit energizes the connected device and reports the amperage over time for the first five seconds of operation; remote computer 700 compares this with known characteristics to determine the type (e.g., HID, fluorescent, incandescent) of lamp and wattage. If the characteristic is not recognized, remote computer 700 assumes the load is of mixed type (i.e., some lamps of one type and some of another) and chooses control parameters acceptable to any likely connected lamp. If the characteristic is recognized, remote computer 700 assigns the remote switching unit as corresponding to a particular lamp type and it is treated as a luminaire with on-board processing. In another application, a more simplistic remote switching unit is used that does not have any on-board processing (e.g., a simple voltage-controlled rectifier circuit). In this instance, the presence of a control line and the absence of an identifying code are used to determine that a “dumb” remote switch without on-board processing is the control for that connected device. In one embodiment, manual identification of a connected device is also provided.

If on-board processing is detected 612, the next stage is to configure 622 the remote device with both control and power parameters. Control parameters are those instructing the device what factors are to determine its operational state, i.e., full-power, dimming level, and off. Power parameters are those setting the electrical characteristics for each of the operational states. For instance, one type of lamp may exhibit extended life if the initial arcing use to produce light upon start up is provided by a particular waveform of electricity, while maintaining that illumination is most efficaciously accomplished through another waveform.

Next, the device is programmed 624 to operate autonomously. For example, a luminaire 731 with an associated ambient light sensor installed in machine area 730 of the industrial facility is instructed to maintain a given ambient light level, supplementing daylight with its own illumination only as needed to maintain that level. In contrast, luminaire 721 in machine area 720 is instructed to maintain full illumination whenever its proximity sensor determines a person is in that area or whenever a milling machine in that area is turned on. In this example, luminaire 721 communicates with a sensor that determines whether that milling machine has been turned on.

If check 612 determines that the device does not have associated processing power, then control parameters for the device will not be determined at the device itself but rather at remote computer 700. Accordingly, the only parameters to be configured 632 are power parameters so as to correspond to the type of device (e.g., HID or fluorescent lamp type and specific wattage). Remote computer 700 then identifies whether any associated devices will be used to provide control for this device in step 634. For example, if luminaire 711 includes an on-board processor but luminaires 712-714 do not, luminaire 711 may be used as a “master” to control “slave” units 712-714, without any processing power being required from remote computer 700 other than facilitating transmission of on-off commands from the master unit 711 to the remote switches for slave units 712-714. Remote computer 700 then programs 636 the associated control device (in this case, luminaire 711) as appropriate for the operation of units 712-714.

Whether or not the connected device has on-board processing capability, the next step 640 is to configure and present a user interface to provide user-friendly information relating to the device. In one embodiment, user interface information is provided at multiple levels of abstraction, from the overall system level down to each connected lamp and sensor.

### Device Network Applications

Device networks in accordance with the present invention allow sensor data to be taken in at each device node and then shared efficiently throughout the entire network. Devices such as lighting, HVAC, and related utilities are distributed throughout every corner of modern facilities and communities. These sensors may include daylight harvesters, motion sensors, video cameras, still picture cameras, temperature sensors, air flow sensors, and many others. These disparate and widely scattered sensors attached to devices on a network can provide a dearth of information regarding the condition and function of a facility. The decoupling of this information from the devices in accordance with the present invention allows for numerous applications which utilize the collected information, some of which are described herein. Applications include both smarter ways to apply the collected information to the control of the device network itself, such as to intelligently cut power usage with minimal impact, and uses of the collected information for other purposes unrelated to the operation of the devices themselves.

In specific embodiments of the invention, data collected from sensors is stored in the devices themselves or is stored remotely in a central controller or server. In specific embodiments of the present invention, devices send collected information through the network to the controller or server in real time. In other specific embodiments, devices transmit their data periodically. Periodic transmission may alleviate the possibility for collisions or overloading the network because devices could take turns sending their data. In other specific embodiments, a central controller or server could query individual devices periodically to have them send their data. This final approach would require two way communications, but it would alleviate the problem of packet collisions and may additionally be more robust in terms of momentary disruptions in the network. This approach is more robust because the central controller or server could send a confirmation signal back to the device upon receipt of the desired information.

Certain advantages can accrue from the storage of information at a remote server. For example, the server can collect sensor data from a facility and can also collect information from the internet regarding local temperature, weather, and major events. This information could be applied in novel ways, as described below, to adjust how the devices on the network are run. In addition, the collected information could be applied to multiple customers of a company that ran the server and installed the networks. This could provide a huge benefit to the company because it would provide new customers with data from similar buildings that could aid in the administration of their own device networks. If a remote server was used it would be beneficial for a firewall to be set up between a particular network's control center and the remote server. This would prevent outside access to the utilities of a particular facility.

By including multiple sensors, each of which can communicate not only with their attached devices, but also networked computer systems, a wide variety of data are available for multiple purposes beyond control of lighting, HVAC, and other environmental systems. In one embodiment, the data collected by the sensors are provided onto a networked computer system, which may be either a locally networked computer or a system elsewhere in the “cloud” of computing systems accessible through wide area networks such as the Internet. Such data are then available for a wide array of purposes, either directly or through knowledge mining facilities. In one application, data collected by the sensors is pushed into a repository and stored for processing in any manner as may be desired. With the cost of data storage decreasing over time, it becomes reasonable to simply store sensor information for uses that may not initially be apparent. For example, if an intermittent problem with a lighting system is noticed, historical data from the sensors is usable to determine when the problem began and can potentially assist in troubleshooting or determining preventative maintenance schedules. In applications in which the sensors are video cameras and similar optical devices, by storing video data new and unexpected uses for the data can be determined after the fact. For instance, in a warehouse application, the warehouse owner may learn that items are being stolen, and the stored video can then be used to help determined when such theft occurred and who was responsible for such theft.

In some installations, the amount of data so collected and processed is significant. Therefore, data processing elements such as the bridges and gateways discussed above are in some embodiments implemented with their own on-board capability for data processing, so as to minimize the amount of data that is constantly pushed onto the cloud of external computing devices described above. In one particular embodiment, a gateway includes a conventional blade server that stores raw sensor data and processes it, sending out to the cloud only exceptions and summary reports. In a specific application, such a gateway with a blade server stores a week's worth of video from all connected video camera sensors, but only sends such data to the cloud upon a specific request (e.g., because goods in the area under surveillance have been stolen) or upon an exception being determined (e.g., a change in color temperature at night suggesting that a lamp is nearing end of life).

The data collected by the network of sensors can be obtained from and applied to control highly disparate devices and systems within a facility. The control of disparate systems poses a problem as they operate on multiple communications protocols and topologies. Additionally, they have varied commands, capabilities, and accessories. This makes the creation of communication and operational control software on a PC a challenge. However, using an API/HAL as described above in accordance with the present invention can alleviate these problems.

In order to maximize the usability of stored sensor information, in one embodiment sensors are uniquely identified and mapped to a facility so that a sensed problem can be quickly rectified. A large warehouse may, for instance, have thousands of lamps, so knowing where a failing lamp is located is quite important. Even if “dumb” sensors are employed, on-board processing by the device to which they are connected allows the data corresponding to the sensor to be tagged with such identification. Using conventional internet protocol (IP) address techniques to identify locations corresponding to sensed data and individual devices is well suited to such purposes, and scales very well. In addition, conventional techniques already exist to help determine geographic locations corresponding to IP addresses.

In specific embodiments of the present invention, data collected from the sensors could be applied to administrate the devices themselves. This idea encompasses the standard reaction of a single device to a connected motion sensor. However, the addition of event-driven networking as described above greatly expands the potential uses of and responses to collected sensor information. For example, as is typical, sensor port 160 may have a motion sensor attached to it to dim the lights when no one is within view. However, in addition, data port 150 may be connected to a remote PC to collect maintenance information, such as changes in current draw or light output that can be used for predictive maintenance on the ballast, lamp, or other components.

In a specific embodiment of the invention, the greater flexibility afforded by event-driven networking can be applied to implement a predicative maintenance system. In the area of predictive maintenance, one embodiment makes multiple uses of stored video data. For example, some fluorescent lamps begin to flicker long before they completely fail. For portions of a video signal that historically do not change rapidly, processing on pixel data is used in one embodiment to determine that the lamp is flickering. Likewise, the color of the light produced by some lamps changes as the lamp nears the end of its useful life. Analysis of otherwise static pixels from a camera sensor is used in one embodiment to predict that a lamp is nearing the end of its life due to such changes in color of light produced. Thermal sensors detecting changes in heat output, and current sensors detecting changes in wattage can likewise be used in certain embodiments to determine lamp or ballast characteristics suggesting the need for maintenance. In one specific embodiment, the current from a multiple-tube fluorescent fixture typically drops when one tube ceases to operate, and in such an embodiment the data from a current sensor is processed so that such changes in current flag the need for tube replacement. By pushing all of this sensed data to remote computer systems, in some embodiments processing of aggregated data provides additional benefits. For example, rated lamp life may not match actual lamp life in many installations, for example due to temperature extremes, humidity, salty air in coastal installations, and the like. Aggregating lamp life information through sensed, stored and processed data permits a facility to better predict its maintenance costs and related resource allocation needs.

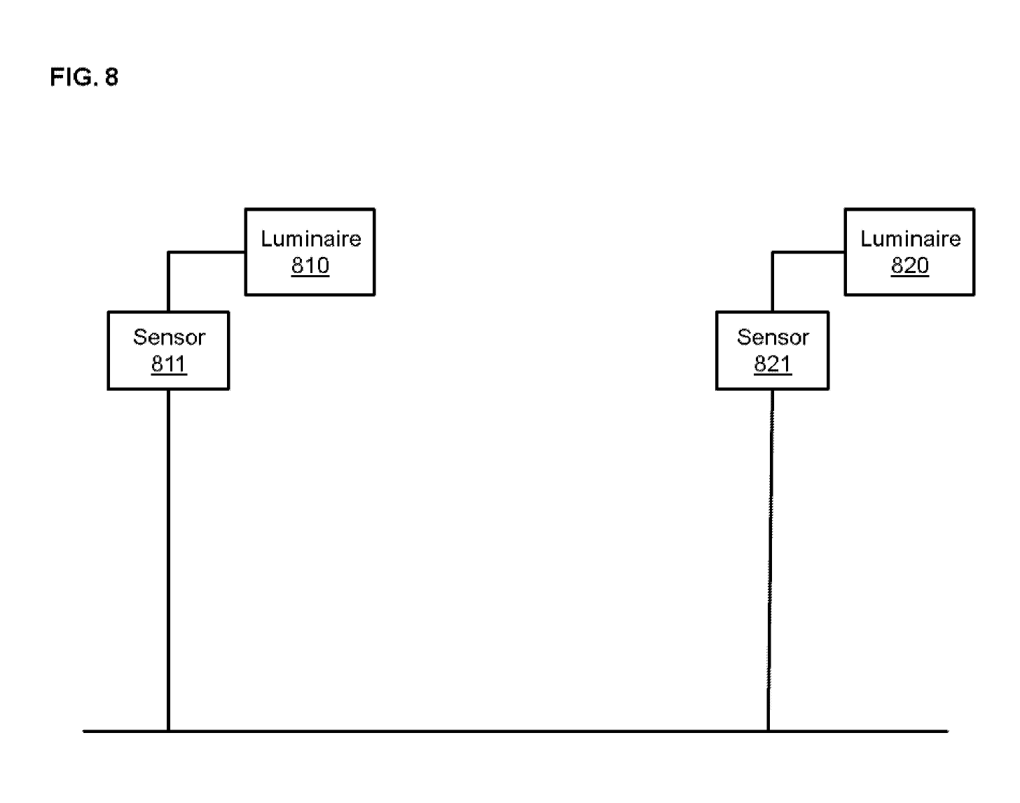

The application of the flexibility afforded by event-driven networking to a device network in the context of a highly efficient road way lighting system can be described with reference to FIG. 8. FIG. 8 displays a system block diagram of a roadway lighting system. The system includes two pairs of lighting devices, luminaire 810 and associated sensor 811, and luminaire 820 and associated sensor 821. In a specific embodiment, luminaire 810 is in communication with luminaire 820. In a specific embodiment, such communication is achieved using conventional wireless networking. In another specific embodiment, a data port such as data port 150 is used in connection with conventional TCP/IP network protocols to connect multiple lighting devices in daisy-chain, hub-and-spoke or other conventional topologies as may be appropriate for a given application. In one specific embodiment, a serial ring topology is used to minimize wiring requirements. In accordance with these embodiments, information pertinent to one lighting device is communicated to another.

In a specific embodiment of the present invention, sensor 811 is a motion sensor configured to detect traffic headed toward the area illuminated by luminaire 810. In one application, detection of such traffic results in luminaire 810 having increased output, as well as the provision of an instruction to luminaire 820 to being increasing its output as well. In many applications, advance warning of the need for illumination allows more gradual increase of illumination at luminaire 820, with correspondingly increased lamp life and full illumination at the time that a motorist enters the area illuminated by luminaire 820. An additional benefit provided by such communication is the avoidance of distracting changes in illumination that would result if luminaire 820 were only controlled by its own sensor 821. Thus, system 800 provides what appears to motorists to be constant illumination, even though luminaires 810 and 820 are only powered up from a resting state in response to proximity detection by sensors 811 and 821.

In specific embodiments, sensor 811 is implemented with a traffic speed sensor to determine a minimal safe lighting level. In one aspect, if traffic at higher speed is detected, luminaires 810 and 820 increase light output for safety reasons. In another aspect, sensors measure line input voltage at each luminaire; due to utility transformers, wiring losses and other factors, the voltage at each luminaire may vary from nominal mains voltage, and by sensing those differences the output of each luminaire is adjusted correspondingly for uniform light output. Likewise, direct measurement of the output from each luminaire by their corresponding sensor permits adjusting the luminaire output as lamps age, as ambient light differs from place to place along the roadway, and the like. In some areas, the presence of animals, whether grazing cattle or deer traversing a roadway may call for increased lighting for safety, so sensor 811 may include proximity sensing of animals. Other environmental conditions, such as rain, snow, haze, fog, smog and the like may in some applications also call for different lighting, and sensor 811 may adjust lighting based on these parameters. In more urban locations, it may be that increases in ambient noise, whether from vehicle engines, tires, horns or pedestrians, suggest a need for greater lighting for safety and in some applications these are sensed via sensor 811.

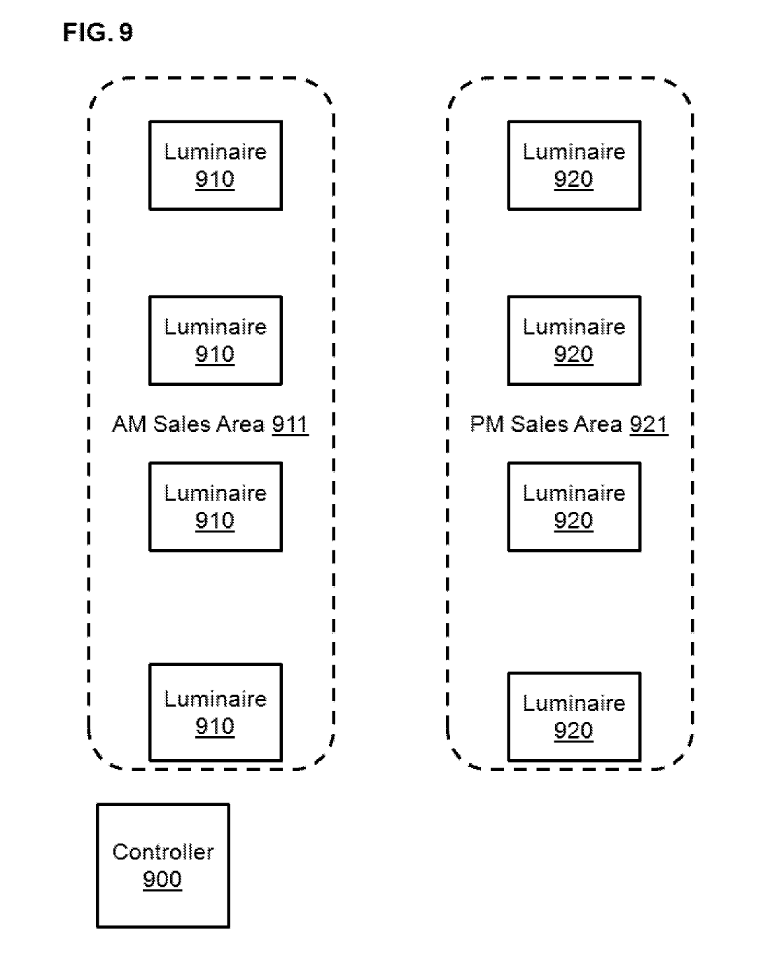

The application of the flexibility afforded by event-driven networking to a device network in the context of a retail establishment lighting system can be described with reference to FIG. 9. Referring now to FIG. 9, a system diagram of a retail facility lighting system is shown. In this instance the system is administrated by a controller 900 though as described before a network of luminaires in accordance with the present invention does not necessarily require a central controller such as controller 900.

Many retail facilities have different areas that, for marketing reasons, the retailer may wish shoppers to visit at different times. For example, a retail location may have an area 911 with products more likely to be purchased in the morning, such as newspapers, coffee and pastries. Another area 921 may have products more likely to be purchased in the afternoon, such as ready-to-eat dinners. Impulse purchases by customers are enhanced by routing customer traffic through the areas having products that customers are more likely to purchase at any particular time. One way to encourage customers to take one path through a store rather than another is through control of lighting. In practice, a brighter pathway is generally preferred by customers to one that is more dimly lit. Thus, in the morning controller 900 increases the output of lighting devices 910 in the morning sales area relative to lighting devices 920. In the afternoon, controller 900 increases the output of lighting devices 920 relative to lighting devices 910 to drive more shopper traffic to the afternoon sales area 921. This simplified description is readily expandable in practice to more complex scenarios. For example, traffic is driven to seasonal areas (Christmas ornaments, Halloween costumes and the like) in the same manner. As an example with still more detail, sunny weather drives more traffic to beach apparel and swim toys, while cold, cloudy weather drives more traffic to snow shovels. Traditionally, retailers have had to physically move fixtures to change traffic flow through stores, or physically move products to maximize opportunities for impulse buying. Controller 900 is configured to programmably alter lighting schemes within a facility to help direct shoppers to particular areas of interest.

In still another application, areas of a store that do not typically result in impulse sales, such as auto parts, are programmably dimmed relative to other portions of the store except during periods of high expected traffic where additional lighting is appropriate. As further detailed below, reductions in illumination to respond to peak energy costs, potential blackouts or brownouts, and the like, are also selectively accomplished in this manner so as to achieve desired energy goals without impacting the effectiveness of the retail location. In some applications, luminaires are best controlled on an individual basis while in others grouping of individual luminaires into zones provides the most desirable results.

The application of the flexibility afforded by event-driven networking to a device network in the context of a manufacturing facility lighting system can be described with reference to FIG. 7. Referring now to FIG. 7, a system diagram of a facility lighting system is shown. As with the prior example, in this instance the system is administrated by a controller 700 though as described before a network of luminaires in accordance with the present invention does not necessarily require a central controller such as controller 700.

The industrial facility illuminated by system 700 includes a storage area 710 with luminaires 711-714, a first machine area 720 with luminaires 721-722, and a second machine area 730 with luminaires 731-732. Industrial facilities have very different lighting requirements than retail facilities. Generally, there is little need to “drive” traffic to one part of the facility or another; the focus instead is in safety, efficiency and cost-effectiveness. In the example facility illuminated by system 700 of FIG. 7, there may be only sporadic need for workers to enter storage area 710 to obtain materials. Therefore, area 710 is selectively illuminated based on proximity sensing and illumination is decreased whenever energy cost and availability considerations dictate a reduction in energy usage. In an alternate application, individual luminaires 711-714 within the area 710 are likewise dimmed or turned off except when needed. Modern industrial facilities sometimes have ambient light sources as well (i.e., daylight harvesters) and luminaires 711-714 are therefore selectively turned off and dimmed, either individually or in a group as desired, based on available daylight in storage area 710. In addition to a storage area, the example facility of FIG. 7 also has two machine areas 720-730. Worker safety may dictate bright lighting whenever a machine is being operated, so depending on the type of machine installed in each area, controller 700 provides appropriate illumination. For example, if machine area 720 comprises a milling machine and machine area 730 comprises a foam packaging machine, the lighting requirements for area 720 may, for safety concerns, be far more exacting than for area 730. In such circumstance, luminaires 721-722 are programmed to operate at full illumination whenever either a worker is detected in area 720 or the milling machine is turned on; daylight harvesting is used only to selectively dim luminaires 721 and 722 a modest amount, and these luminaires are never disabled for energy-saving reasons. On the other hand, luminaires 731 and 732, which illuminate the area of the foam packaging machine, serve a far less dangerous area, and accordingly are dimmed or turned off as needed due to availability of ambient daylight, energy savings considerations and the like.

In a specific embodiment, the ability of each luminaire in an event-driven network to respond to sensor data in its own manner based on its location and purpose can be put to use in an industrial facility. For example, a sensor event indicating that a person is in storage area 710 during regular working hours might indicate a need to illuminate all of luminaires 711-714, 721-722, and 730-731 to full power since it might suggest that the machines are about to be put to use, but the same event occurring during nonworking hours might not trigger luminaires 721-722 and 730-731 in working areas 720 and 730 because it is more likely that the presence of the person is not related to the machines about to be put into use. By sending an event message rather than a command message, each luminaire can determine based on its own programming whether to turn on, turn off, dim, etc. This greatly reduces the complexity of command programming and allows for full flexibility of the system to achieve any desired manner of operation.

In a specific embodiment of the present invention the flexibility afforded by event-driven networks is applied to the common problem with motion sensors for lighting in that people who are sedentary (e.g., those typing at a computer) may not move enough for the sensors to think that a space is occupied, with the result being that room lights may turn off when the room is in fact occupied. In accordance with the present invention, instead of a conventional motion sensor system that requires the user to wave hands or get up to re-trigger the lights, in one embodiment, luminaire 100 responds not only to a motion sensor, but also to messages indicating that the illuminated area is indeed occupied. Specifically, examples of other inputs include network activity emanating from the user's computer (interpreted as an indicator that the person is present in the room), and an event indicating that the user's computer has gone into a hibernation mode (interpreted as an indicator that the room may be empty). In some embodiments, fuzzy logic is used to learn which combinations of events are most likely to indicate presence or absence of a person. For instance, if one set of events that are initially interpreted as appropriate to turn off the lights is immediately followed by motion after the lights are turned off, that set of events will, over time, be interpreted as not likely a good indicator that the room is empty. Thus, for each user the system learns what set of events are normal when the room is occupied, and what set of events is more likely to indicate that there is no one in the room.

Data collected from sensors could be used for multiple purposes unrelated to the administration of the devices themselves. In specific embodiments, sensor port 160 and data port 150 operate independently of one another. In other specific embodiments, the operation of the sensor connected to sensor port 160 can be monitored by a controller via data port 150 receiving messages delivered from processor 135. This allows for a single purpose sensor to serve in secondary functions. For example, a connected motion sensor's primary function is to dim the lights when people are not in the area. With the ability to monitor the motion sensor via data port 150, the motion sensor's operation can be logged to track and report on occupancy patterns in a given areas. In particular embodiments, these patterns are used in a variety of ways such as logging customer traffic patterns or work studies. Such information is also usable for resource management purposes, such as determining based on sensor data which portions of a retail facility should be staffed with more store clerks, based on customer activity. Furthermore, in one embodiment each luminaire is identified in the system with its corresponding physical location, so that data concerning that luminaire is correlated with a physical location. In one specific embodiment, each device has a unique internet protocol address, and those addresses are mapped in a computer system to corresponding physical locations. In certain applications, integration with other environmental, cultural, legal or other factors is enabled through use of ports 150 and 160 as described above. For instance, there may be legal occupancy control requirements that can be monitored and addressed through proximity sensors, cameras, or light beam subsystems connected to ports 150 and 160. In another application, climate data is used to modify the system's control of grow lights in a greenhouse. Other applications, including temperature/humidity control, advertising (billboards), architectural lighting, recreational lighting (indoor and outdoor) and retail “high bay” lighting will be apparent to those skilled in the art. In one application for low-light situations, an infrared camera us used for the imaging applications described herein. In another specific embodiment, monitoring data from a daylight harvesting sensor via data port 150, allows for ambient light to be logged to determine length of day, or determining when outside doors are open (which may be cross referenced with HVAC systems to determine inefficiencies in worker habits).

As described above, device networks in accordance with the present invention allow for a great degree of flexibility in applying sensor data to the administration of the devices and the expansion of the device networks functionality. In addition, methods described above disclose how these networks can be used to obtain and store a great deal of information regarding the status and operation of a facility or other networked area. These capabilities can be combined to produce an even greater spectrum of capabilities to a device network. In particular, these capabilities can be applied to offer highly intelligent demand response device networks. These networks allow a facility to reduce energy usage at any given time with minimal impact upon the general operation of the facility. Since these networks alter the energy usage differently depending upon the given time at which a request for reduced energy is sent, these networks can be referred to as dynamic demand response (DDR) networks.

Many facilities suffer penalty charges when their energy use crosses a peak demand threshold. These facilities may have meters that can alert them when their energy usage is approaching this threshold, giving them an opportunity to implement immediate changes to avoid crossing this threshold. These changes typically mean reducing the energy consumption by performing preconfigured actions such as automatically turning lights off and/or reducing HVAC loads. These reductions are constant across the facility.

By monitoring feedback (as described above) where human traffic is logged in a database, when the peak demand threshold is approached, the traffic can be analyzed versus the current date/time, and intelligent choices can be made to reduce energy consumption with less impact to the facilities function. For example, a facility using a conventional method may dim the lights 15% across the facility affecting all workers. In contrast, in one embodiment of the present invention, worker traffic patterns are logged over time and, for example, it may have been determined that one corner of the facility contains 80% of the workers for a given time of day. The lights in this corner are then only dimmed 5%, whereas other areas that have nearly no traffic are dimmed 20%, and the remaining sections are dimmed 15% to achieve a desired energy reduction. It is extremely important for DDR to take into account stored trended data because a power reduction request could be sent at a specific time when employees are engaged in a temporary activity that they would not normally be engaged in. Perhaps the request is sent when everyone is in the break room singing happy birthday. If the current data was used to decide how power usage should be reduced, everyone might return to a dark work area. If instead, trended data was used the network would know that the work area is generally highly active at that particular time and the employees would return to a well lit office area.

DDR methods in accordance with the invention can be applied on a larger scale. For example, such methods could be used by a utility company that needed to reduce the load on a given grid to avoid a brownout. The utility contracts with its customers to allow remote operation of their energy load reduction system. Conventionally, the utility sends a signal to customers to reduce their loads by 5% across the board and all participating consumers must lower their load by 5%. In contrast, in a specific embodiment the utility monitors human traffic and activities and makes intelligent decisions. For instance, Facility A is a manufacturing operation with workers working in the morning hours, whereas Facility B is a grocery store. The utility has monitored and logged traffic in the facilities and when the grid load must be reduced at 10 a.m., it is found that statistically at that time of day there is heavy human traffic in Facility A (where the workers are working) versus light traffic in the grocery (facility B). The utility then dims the lights in Facility A only 3%, whereas it dims the lights in Facility B 9%. Later in that same day around 4 pm, the load is to be reduced again. This time the logged data statistically shows that the workers have now all left and Facility A has light traffic, whereas Facility B, the grocery, has heavy traffic (possibly because the workers from Facility A have stopped there on the way home). This time the utility makes the dynamic decision to dim the lights in Facility A 15%, and not dim Facility B at all.

The systems discussed herein are usable for more than simply control of lighting fixtures. Related systems operate based on many of the same parameters. For instance HVAC systems and other utilities share many characteristics with lighting systems, even though different parameters may impact their operation. More specifically, it may be that large amounts of ambient daylight indicate a reduced need for electrical lighting, but an increased need for HVAC operation. The same sensors used to adjust lighting parameters are usable to control other systems, whether HVAC, alarm, security (access controls) or otherwise. In one embodiment, a remote computer is programmed to provide control signals to, for instance, HVAC zones within a facility. For example, using the industrial facility of FIG. 7, HVAC zones in storage area 710 and machine areas 720 and 730 are selectively controlled based on the presence of personnel, ambient conditions and energy costs. To give one specific example, as an electric utility provides notice of increasingly severe peak load conditions, first luminaires 711-714 are dimmed, then cooling for storage area 710, then cooling for machine areas 720 and 730, then lighting for machine area 730 is dimmed, and finally lighting units 711-714 are turned off sequentially in order to minimize peak load conditions. In another example, off-hours movement detection in storage area 710 results in illumination of whichever luminaires 711-714 are in closest proximity to the movement, so as to give a warning to unauthorized persons that their presence has been detected and they are being tracked. In still another example, ambient light sensors co-located with luminaires provide highly location specific information as to where ambient light is sufficient for operational requirements, and based on threshold ambient light values, lamps are selectively dimmed and turned off in response to peak load conditions.

Although embodiments of the invention have been discussed primarily with respect to specific embodiments thereof, other variations are possible. Various configurations of the described system may be used in place of, or in addition to, the configurations presented herein. For example, although the devices were discussed often with reference to luminaires the invention will function with any powered utility. As used in this specification, and in the appended claims the term “powered utility” is meant to refer to any energized device that aides in the administration or performance of a facility's utilitarian functions. In addition, network topologies and protocols applied for use with embodiments of the invention are not limited to those mentioned specifically herein as the invention can function using any type of network, network topology, and network protocol. Also, controllers mentioned herein can be personal computers, servers, or devices designed particularly for the uses described. Also, networks were often mentioned as being used in facilities but this should not limit the invention to use inside a building as the work facility is intended to cover any area where utilities are applied or sensor data is available. Also, the invention is not limited to use with specific sensors mentioned herein as it can function with any device that is capable of obtaining information. When one device in accordance with the present invention is being discussed with reference to a controller, augmented legacy device, or any other device that is in accordance with the present invention can be referred to herein and in the appended claims as a “similar apparatus”. When the term “connection” is used herein or in the appended claims the term is meant to cover both wired and wireless connections.

Those skilled in the art will appreciate that the foregoing description is by way of example only, and is not intended to limit the invention. Nothing in the disclosure should indicate that the invention is limited to systems that require power from a main grid or that serve any particular function. Functions may be performed by hardware or software, as desired. In general, any diagrams presented are only intended to indicate one possible configuration, and many variations are possible. Those skilled in the art will also appreciate that methods and systems consistent with the present invention are suitable for use in a wide range of applications encompassing any related to the utilization of information obtained from a set of networked utility devices.

What is claimed is:

1. An apparatus for control of a powered utility comprising:
a processor capable of altering a state of said powered utility;
a data port configured to transmit a set of messages, said set of messages comprising a message delivered from said processor; and
wherein said data port is configured to autonomously form a network communication channel with a similar apparatus.

2. The apparatus of claim 1, wherein said powered utility is one of a lighting device, an HVAC device, an environment regulator device, an air conditioning device, a heating device, an alarm device, a power utility routing device, and a natural gas utility routing device.

3. The apparatus of claim 1, further comprising:
a sensor port configured to connect to a sensor device;
wherein said sensor port is configured to automatically interface with said sensor device.

4. The apparatus of claim 3, wherein:
said message is received and stored by a network server; and
said set of messages are transmitted intermittently in response to a query message from said network server.

5. The apparatus of claim 1, wherein:
said data port is configured to receive a second set of messages; and
said processor is configured to selectively alter said state of said powered utility based on said second set of messages.

6. The apparatus of claim 5, further comprising:
a luminaire;
a first message of said second set of messages, said first message instructing said processor to limit a lumen output of said luminaire to a first maximum value; and
a second message of said second set of messages, said second message instructing said processor to limit a lumen output of said luminaire to a second maximum value;
wherein said processor adjusts said second maximum value in proportion to a ratio of said first maximum value to a full power value.

7. The apparatus of claim 5, said apparatus further comprising:
a sensor port configured to connect to a sensor device, said sensor port configured to receive sensor data from said sensor device;
wherein said similar apparatus is configured to selectively alter a separate state of a separate utility based on said sensor data.

8. A system for control of a set of powered utilities comprising:
a first device comprising a first processor capable of altering a first state of a first powered utility, said first device further comprising a first data port configured to transmit a set of messages, said set of messages including a transmitted message delivered from said first processor; and
a second device comprising a second processor capable of altering a second state of a second powered utility;
wherein said second processor is configured to selectively alter said second state based on said transmitted message.

9. The system of claim 8, wherein said first and said second devices are individually one of a lighting device, HVAC device, environmental regulator device, an air conditioning device, a heating device, an alarm device, a power utility routing device, and a natural gas utility routing device.

10. The system of claim 8, wherein:
said second device further comprises a second data port; and
said first device is configured to autonomously configure networked communication with said second device when said first data port is provided with a connection to said second data port.

11. The system of claim 8, wherein:
said first device and said second device are enabled street lights;
said transmitted message comprises information from which a presence and a direction of an automobile passing a region monitored by said first device can be discerned; and
said second device alters a lumen output based on said transmitted message

12. The system of claim 8, further comprising:
a network server networked with said first device and said second device;
wherein said network server is configured to receive and store said transmitted message and trend data contained in said transmitted message with other data to create a database.

13. The system of claim 12, wherein:
said first device alters said first state of said first powered utility to decrease said first powered utility's power consumption by a first percentage;
said second device alters said second state of said second powered utility to decrease said second powered utility's power consumption by a second percentage; and
said first percentage and said second percentage are set based on said database to minimize the aggregate effect on a human element utilizing said first powered utility and said second powered utility.

14. The system of claim 8, wherein:
said first device and said second device are connected in a serial ring;
said set of messages are packaged according to a serial ring protocol;
said second device further comprises a serial-out port connected to a communications bridge; and
said communication bridge allows the translation of said set of messages to a different network protocol.

15. The system of claim 14, wherein:
said communication bridge is configured to act as a communication gateway by returning a subset of messages to said serial ring; and
said subset of messages are pertinent only to said serial ring.

16. The system of claim 8, further comprising:
a central controller;
wherein said first data port is configured to receive a second set of messages from said central controller; and
said first processor is configured to selectively alter said first state of said first powered utility based on said second set of messages.

17. The system of claim 16, wherein:
said first device and said second device are enabled indoor lighting fixtures;
said transmitted message comprises information indicating a time of day; and
said second device alters a lumen output based on said transmitted message to direct the flow of persons in a facility.

18. An apparatus for control of a powered utility comprising:
a processor capable of altering a state of said powered utility;
a data port configured to transmit a set of messages, said set of messages including a transmitted message delivered from said processor; and
a sensor port configured to connect to a dumb sensor device;
wherein said processor intelligently processes basic sensor data received from said dumb sensor device.

19. The apparatus form claim 18, wherein said sensor port is configured to automatically detect and interface with said dumb sensor device when said sensor port is provided with a connection to said dumb sensor device.

20. The apparatus from claim 19, wherein said processor produces event data based on said basic sensor data, said event data configured to be used by a similar apparatus to selectively alter a second state of a second powered utility.
